(19) United States
(12) Patent Application Publication
(10) Pub. No.: US 2026/0305881 A1
(43) Pub. Date: Oct. 8, 2026

(54) LIQUID DISPENSER

(71) Applicant: Yehiel Vashdi, Alei-Zahav (IL)

(72) Inventor: Yehiel Vashdi, Alei-Zahav (IL)

(21) Appl. No.: 19/481,275

(22) PCT Filed: May 7, 2024
(86) PCT No.: PCT/IL2024/050432

§ 371 Date: Nov. 4, 2025

(30) Foreign Application Priority Data
May 11, 2023 (IL) 302885
Mar. 12, 2024 (IL) 311435

(51) Int. Cl. A47K 5/13; A47K 5/12

(52) U.S. Cl. CPC A47K 5/13; A47K 5/1214

(57) ABSTRACT

A liquid dispenser for one-handed dispensing comprises a substantially horizontal and longitudinally closed transfer member configured with a manual compressed air generating mechanism, wherein the transfer member is contactable by a first portion of an actuating hand; a substantially horizontal actuator operatively coupled with the transfer member to which an actuating force is appliable with a second portion of the same actuating hand; an adapter with which an unoccluded terminal end of an inverted bottle containing a desired liquid and in liquid communication with the transfer member is releasably securable; a base with which the adapter is engageable, the base configured with a downwardly extending throat that is engageable and in fluid communication with, an element of the transfer member; a valve unit seatable in a valve seat provided with the throat of the base, the valve unit configured to prevent unwanted liquid from being discharged through the unoccluded terminal end of the inverted bottle; and a fluid exchange port in fluid communication with the transfer member, wherein an unseating force causing the valve unit to become unseated from the valve seat and the contained liquid to be gravitationally discharged through the valve unit and through the transfer member is appliable onto the valve unit by compressed air that is generated by the compressed air generating mechanism within an interior of the transfer member upon application of the actuating force, wherein a dose of the contained liquid is dispensable via the transfer member and the fluid exchange port into the actuating hand upon application of the actuating force with the second portion of the actuating hand.

### FIELD OF THE INVENTION

The present invention relates to the field of liquid dispensers. More particularly, the invention relates to a dispenser for viscous liquids.

### BACKGROUND OF THE INVENTION

Showering promotes good hygiene by washing away bacteria and accumulated dirt and sweat. In addition to the benefits of cleanliness, showering with warm or hot water is a relaxing experience that induces a widening of blood vessels and an increase in blood flow, assisting in transport of soreness-causing lactic acid away from tired muscles.

Some industrious people are involved in many tasks during the day and have limited free time. Such people are desirous of reducing the time needed to take a shower.

One time consuming shower-related action is discharging a viscous liquid such as shampoo or body cream from a squeeze bottle. The contained liquid is able to be dispensed upon inverting the bottle and squeezing the flexible walls of the bottle. As a result, the bottle volume is reduced and air therewithin is slightly compressed to force the viscous liquid shampoo downwardly through the bottle opening. However, the internal air within a squeeze bottle that is in a near-empty condition becomes compressed to a smaller degree upon being squeezed than when the squeeze bottle is substantially full. The downward flow of the viscous flow is impeded by the adhesive force of the liquid with respect to the inner bottle surface since the internal air is ineffective in driving the liquid. Some bathers lack the patience to wait until the remaining liquid in the bottle finally gravitates through the opening, and discard the bottle, leading to unnecessary material wastage.

If the squeeze bottle is set in the inverted position for a prolonged period of time, unwanted discharge of the liquid occurs when the bottle closure is opened.

It is an object of the present invention to provide a dispenser for a viscous liquid that is able to be instantly and effortlessly dispensed even when the squeeze bottle containing the viscous liquid is in a near-empty condition.

It is an additional object of the present invention to provide a dispenser for a viscous liquid that facilitates a one-handed dispensing operation into the squeezing hand, to facilitate speedier showering than has been known heretofore.

It is an additional object of the present invention to provide a cost effective dispenser for a viscous liquid that cooperates with a conventional, commercially available squeeze bottle without introducing any mechanical or electromechanical element internally within the squeeze bottle.

It is yet an additional object of the present invention to provide a dispenser for a viscous liquid that limits or completely eliminates wastage of the liquid when not dispensed.

Other objects and advantages of the invention will become apparent as the description proceeds.

### SUMMARY OF THE INVENTION

A liquid dispenser for one-handed dispensing comprises a substantially horizontal and longitudinally closed transfer member configured with a manual compressed air generating mechanism, wherein said transfer member is contactable by a first portion of an actuating hand; a substantially horizontal actuator operatively coupled with said transfer member to which an actuating force is appliable with a second portion of the same actuating hand; an adapter with which an unoccluded terminal end of an inverted bottle containing a desired liquid and in liquid communication with the transfer member is releasably securable; a base with which the adapter is engageable, the base configured with a downwardly extending throat that is engageable and in fluid communication with, an element of the transfer member; a valve unit seatable in a valve seat provided with the throat of the base, the valve unit configured to prevent unwanted liquid from being discharged through the unoccluded terminal end of the inverted bottle; and a fluid exchange port in fluid communication with the transfer member, wherein an unseating force causing the valve unit to become unseated from the valve seat and the contained liquid to be gravitationally discharged through the valve unit and through the transfer member is appliable onto the valve unit by compressed air that is generated by the compressed air generating mechanism within an interior of the transfer member upon application of the actuating force, wherein a dose of the contained liquid is dispensable via the transfer member and the fluid exchange port into the actuating hand upon application of the actuating force with the second portion of the actuating hand.

In one aspect, the compressed air generating mechanism comprises an air-deliverable chamber which is in fluid communication with an orifice of the valve unit and an expandable element in force transmitting relation with the actuator, the expandable element configured to expand in response to the applied force and to cause a volume of the air-deliverable chamber to become reduced and to generate the compressed air.

In one aspect, the transfer member is additionally configured with a transfer chamber isolated from the air-deliverable chamber within which the dose of the contained liquid discharged through the valve unit is received prior to being dispensed via the fluid exchange port.

In one aspect, the base is annular and the element of the transfer member with which the throat is engageable is a tube upwardly extending from, and in fluid communication with, a substantially horizontal tube of the transfer chamber.

In one aspect, the valve unit is releasably engageable to an inner face of the throat of the base.

In one aspect, the valve unit comprises a tubular body, a solid unbored ball which is vertically displaceable within an interior of the body, and a lower surface configured with an orifice constituting a valve seat which is seatable by the ball in order to prevent discharge of the contained liquid. An unseating force causing the ball to become unseated from the valve seat and enabling discharge of the contained liquid through the valve unit and the transfer chamber is appliable onto the ball by compressed air that is generated within an interior of the transfer chamber upon applying the actuating force.

In one aspect, the valve unit is additionally configured with one or more vertical displacement limiting elements protruding inwardly from an inner face of the tubular body, upward displacement of the ball in response to application of the unseating force being limited upon contacting one of the vertical displacement limiting elements.

In one aspect, the base is releasably engageable with the adapter.

In one aspect, the adapter is irremovably coupled with, or attached to, the base.

In one aspect, the throat of the base is releasably engageable with an element of the transfer member.

In one aspect, the throat of the base is irremovably coupled with, or attached to, an element of the transfer member.

In one aspect, the adapter comprises a sealing section that is securable within a bottle opening at the unoccluded terminal end of the inverted bottle, and a connection section for connection with the base. The sealing section may be of annular frusto-conical construction and comprise a peripheral wall that is oblique relative to a longitudinal axis of the adapter, and a plurality of sealing rings which are integrally formed with the oblique wall.

In one aspect, the adapter comprises one or more elements for frictionally holding the terminal end of the inverted bottle, and a connection section for connection with the base.

In one aspect, the dispenser is suitable for dispensing of a viscous liquid.

A system comprises the dispenser and a mounting element by which the dispenser is supported.

A manually operated universal liquid dispenser comprises a pump member, an actuator mechanically connected to the pump member, an annular closure configured with threading that is attached to a distal housing element of the pump member, a flexible conduit attached to a distal end of the pump member, and an annular variably shaped adapter comprising a sealing section and a threaded connection section, wherein the connection section of the adapter is threadedly engageable with the closure and the sealing section of the adapter is sealingly securable within an interior of a neck of a bottle while the conduit is introducible through the interior of the bottle neck so as to be in liquid communication with the liquid contained within the bottle, and wherein the liquid contained within the bottle is dispensable upon manipulation of the actuator.

In one aspect, the adapter is removable from the bottle neck of a first size and is sealingly securable within the interior of a bottle neck of a second size.

In one aspect, the adapter is of frusto-conical construction and may comprise a plurality of parallel integral sealing rings.

A system comprises the manually operated universal liquid dispenser and a bottle containing a liquid which is configured with a neck within an interior of which the sealing section of the adapter is sealingly securable.

### BRIEF DESCRIPTION OF THE DRAWINGS

In the drawings:

FIG. 1 is a perspective view of a liquid dispenser and a wall mount for the liquid dispenser;

FIG. 2 is a front view of the liquid dispenser and wall mount of FIG. 1;

FIG. 3 is another perspective view of the liquid dispenser and wall mount of FIG. 1, shown together with a bottle containing the liquid to be dispensed;

FIG. 4 is an exploded side view of the liquid dispenser of FIG. 1, according to one embodiment;

FIG. 5 is a perspective view of the liquid dispenser of FIG. 1 when assembled, according to one embodiment;

FIG. 6 is an exploded perspective and cross sectional view of some components of the liquid dispenser of FIG. 1, according to one embodiment;

FIG. 7 is a cross sectional view of the liquid dispenser of FIG. 6, shown when assembled and schematically illustrating forces that are transmittable thereby;

FIG. 8 is a perspective view from the bottom of a sectioned transfer member usable in conjunction with the liquid dispenser of FIG. 6, shown when an actuating force is released;

FIG. 9 is a perspective view from the bottom of the sectioned transfer member of FIG. 8, shown when an actuating force is applied;

FIG. 10 is a perspective top view of the liquid dispenser of FIG. 1 which is provided with an adapter suitable to engage an unthreaded bottle neck, according to an embodiment;

FIG. 11 is a perspective view of a liquid dispenser and a wall mount according to another embodiment;

FIG. 12 is a perspective cross sectional view of the adapter used in the conjunction with the liquid dispenser of FIG. 11;

FIGS. 13 and 14 are a perspective view of two prior art liquid soap bottles, respectively, each demonstrating different coupling means for a corresponding dispenser;

FIG. 15 is an exploded view of a universal liquid soap dispenser according to an embodiment;

FIG. 16 is a side view of the dispenser of FIG. 15 when partially assembled, prior to being coupled to a bottle;

FIG. 17 is a perspective view of an adaptor with a smooth conic portion, according to another embodiment of the invention.

### DETAILED DESCRIPTION OF THE INVENTION

The liquid dispenser facilitates a one-handed dispensing operation by which the dispensed liquid including a viscous liquid such as shampoo or body cream is discharged from a bottle coupled with an adapter of the dispenser into the actuating hand. The one-handed dispensing operation is made possible in conjunction with a substantially horizontal transfer member onto a terminal end of which fingers of the actuating hand apply a reactive force and a substantially horizontal actuator operatively coupled with the transfer member to which an actuating force is preferably applied with the thenar eminence of the actuating hand, located at the palm side of the thumb. Upon application of the actuating force, a dose of the liquid is urged to be discharged from the bottle into the interior of the transfer member and then dispensed into the palm of the actuating hand.

The transfer member is configured with a mechanism responsive to the manual actuating force that generates a burst of air for initiating the dispensing operation.

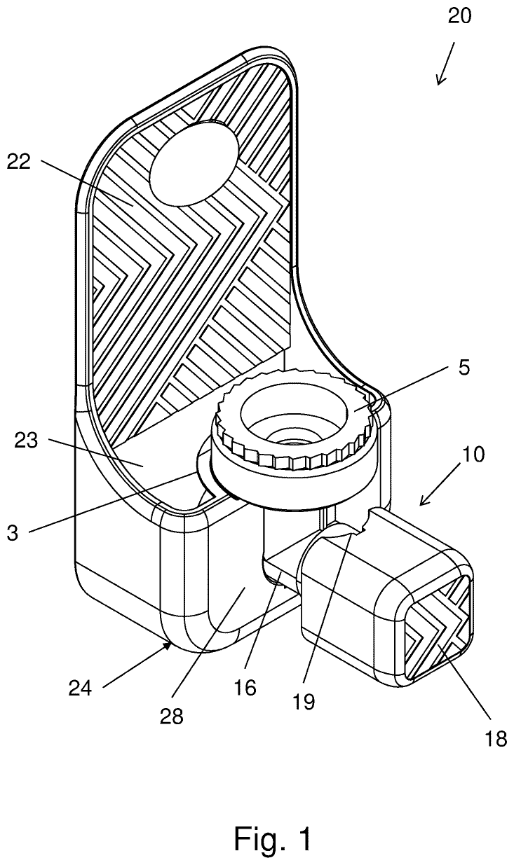

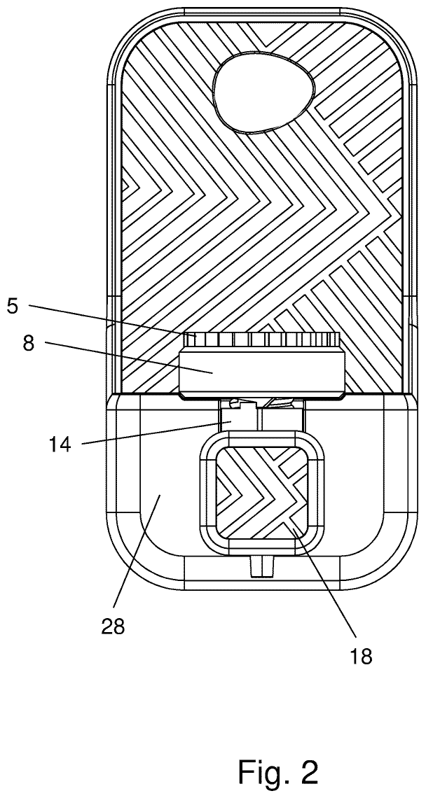

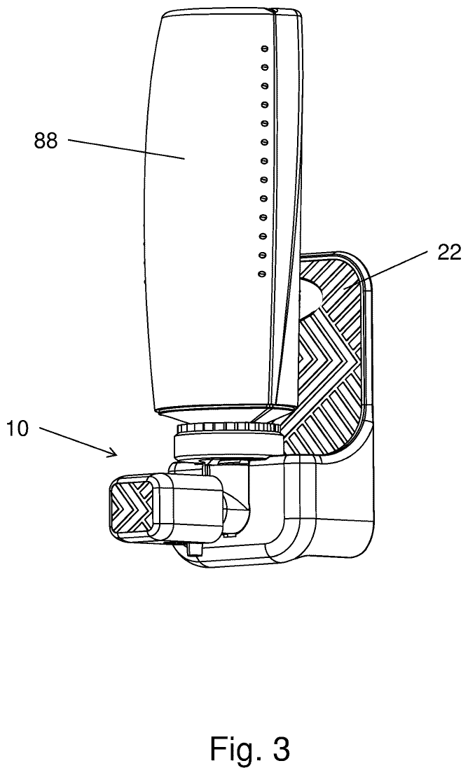

FIGS. 1-3 illustrate a liquid dispenser according to one embodiment, generally indicated by numeral 10, and wall mount 20 to which at least one component of liquid dispenser 10 is fixed. Dispenser 10 is shown in FIGS. 1 and 2 when uncoupled to a bottle, and FIG. 3 illustrates dispenser 10 when coupled with an inverted bottle 88, which may be a commercially available bottle adapted to be squeezed in order to dispense the contained liquid, generally a viscous liquid, or may be a dedicated bottle. As will be appreciated from the following description, the dedicated bottle may be rigid since the liquid is able to be dispensed with compressed air generated by means of the actuated mechanism, and not by squeezing a flexible bottle as practiced by the prior art while requiring considerable effort when the bottle is in a near-empty condition.

Wall mount 20 has a substantially vertical mounting surface 22 adapted for mounting on a wall surface, such as a shower wall, by conventional mounting means, a substantially horizontal support surface 24 for supporting dispenser 10 thereunder, and a front vertical plate 28 for protecting the transfer member while curving to the side so as to be integral with mounting surface 22. The wall-facing edge 3 of support surface 24 is slightly horizontally spaced from mounting surface 22, allowing fingers of the actuating hand to be introduced through a window 23 formed in mounting surface 22 and to engage the terminal end of the transfer member which is located at the same height of at least a portion of window 23 relative to support surface 24.

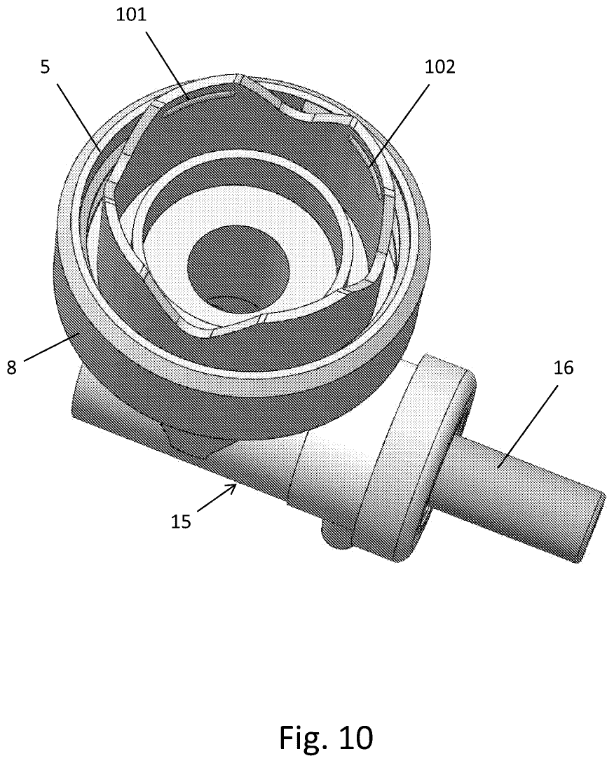

Dispenser 10 comprises annular base 8 and adapter 5. Adapter 5 is able to be secured with the neck of inverted bottle 88 and is releasably coupleable with base 8 in order to accommodate differently sized or differently configured bottle necks. For example, a threaded bottle neck is able to be secured to an adapter configured with corresponding threading, and an unthreaded bottle neck is able to be frictionally engaged with an adaptor configured with dedicated frictional elements (see frictional elements 101 and 102 in FIG. 10). If the bottle neck is provided with a hinged flip-top cap, the cap can be simply removed from the bottle neck. A vertical tube 14 of the transfer member extends downwardly from base 8 and is positioned inwardly to protection plate 28, while a portion of adapter 5 and base 8 may protrude outwardly from protection plate 28. Substantially horizontal actuator 16 extends outwardly from the transfer member and across a central aperture formed in protection plate 28, and a cover 18 is fixed to the outward end of actuator 16. Actuator cover 18 may be formed with a cutout 19 at an inward portion thereof so as not to interfere with tube 14 when actuator 16 is pressed inwardly during an actuating operation.

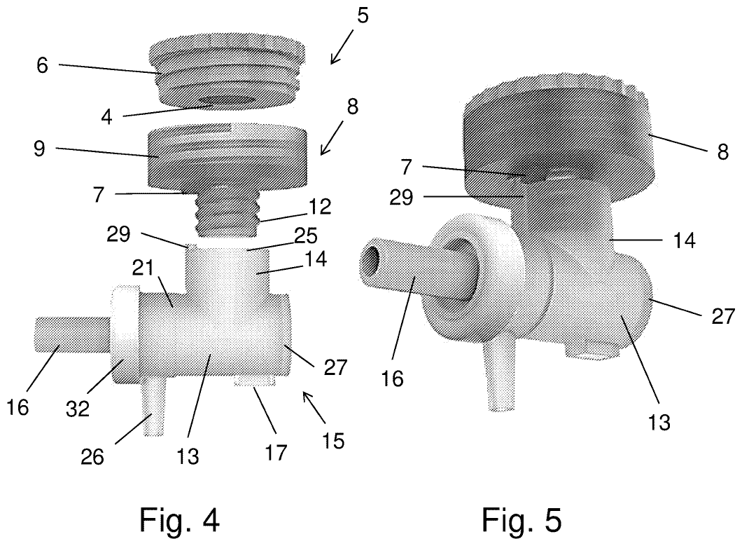

As shown in FIG. 4, the outer peripheral wall of adapter 5 is formed with threading 6 which is engageable with corresponding threading 9 formed in the inner wall of base 8 and with a central aperture 4 through which viscous liquid is dischargeable from the inverted bottle. Downwardly extending throat 12 of base 8 in turn is threadedly engageable with internal threading provided with tube 14 of transfer member 15. As shown in FIG. 10, the inner periphery of adapter 5 may be formed with frictional elements 101 and 102, while the outer peripheral wall of this embodiment of adapter 5 is formed with threading as indicated by numeral 6 in FIG. 4. The configuration shown in FIG. 10 enables an unthreaded bottle neck to be frictionally engaged with adapter 5.

Transfer member 15 is shown to be T-shaped, being configured with a rigid horizontal tube 13 and a rigid vertical tube 14 extending slightly upwardly from horizontal tube 13, although other configurations of the transfer member are also in the scope of the invention. Horizontal tube 13 is provided with an inlet 17 through which air is introducible into the transfer member interior, for example positioned at the bottom of horizontal tube 13. Inlet 17 may be an inlet of a check valve that allows ambient air to be introduced into the transfer member interior and prevent outward escape of the introduced ambient air from the the transfer member interior. Horizontal tube 13 is able to be connected to the support surface of the wall mount by an upwardly extending fastener introduced through a fixture which is provided at the bottom of horizontal tube 13 without covering inlet 17, or, alternatively, horizontal tube 13 is formed integrally with the support surface.

An interface element 21 provided within the transfer member interior and constituting at least part of the compressed air generating mechanism is operatively connected to one end of horizontal tube 13. Elongated fluid exchange port 26 extends downwardly from horizontal tube 13 and is aligned with interface element 21 while being in fluid communication with the interior of transfer member 15. Through port 26 liquid is able to be discharged from the interior of transfer member 15, generally in conjunction with an internal transfer chamber adjacent to interface element 21. Port 26 is shown to be axially spaced from vertical tube 14, although embodiments whereby tube 14 and port 26 are axially aligned are also in the scope of the invention. Endwall 27 fixedly attached at the second end of horizontal tube 13 on the other side of vertical tube 14 also prevents the escape of the introduced ambient air, urging the ambient air, when compressed, to flow through throat 12 of base 8.

A protective covering 32 for the compressed air generating mechanism surrounds, and is secured to, interface element 21 while occluding the interior of transfer member 15. Rigid tubular actuator 16, shown without its cover, extends through the center of covering 32 and is connected to a driving member or to a recessed occluding element which is in force transmitting relation with interface element 21, or passes through interface element 21 and is in force transmitting relation with another element of the compressed air generating mechanism. Although actuator 16 is shown to be tubular for material savings, any other configuration of the actuator, including a solid unhollowed element, is within the scope of the invention insofar that it is pressable during a one-handed operation, particularly by the palm of the actuating hand.

In other embodiments, another component of the dispenser, such as base 8 or endwall 27 of horizontal tube 13, is attached to another type of support surface. In order to ensure that actuator 16 will be accessible to the user, vertical tube 14 of the dispenser is configured with angular positioning means. As shown in FIGS. 4 and 5, a narrow vertically extending positioning element 29 protrudes radially outwardly from a specific region of vertical tube 14 and slightly vertically above the upper edge 25 of vertical tube 14. Also, a tooth 7 of an angularly limited shape slightly projects downwardly from the underside 11 of base 8 and extends radially outwardly from throat 12. Accordingly, the degree of rotation of base 8 relative to vertical tube 14 when throat 12 is being threadedly engaged with vertical tube 14 is limited when positioning element 29 abuts tooth 7.

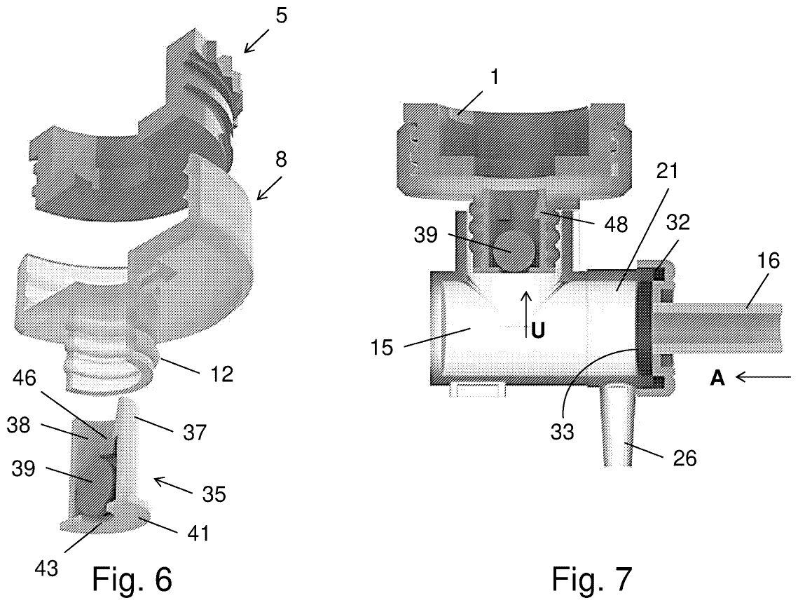

As shown in FIGS. 6 and 7, liquid dispenser 10 also comprises a valve unit 35 that prevents unwanted liquid from being discharged through the opening of the inverted bottle whose neck is secured to adapter 5, for example frictionally secured to adapter 5 by means of frictional elements 1. Valve unit 35 is securely introduced within the interior of throat 12 of base 8, such as by being threadedly engaged together.

In one embodiment, valve unit 35 is a non-rotating ball valve that comprises a tubular body 37 and a solid unbored ball 39, e.g. made of stainless steel, which is vertically displaceable within the interior of body 37. The lower surface 41 of valve unit 35, which may have a slightly larger diameter than body 37, is configured with an orifice 43 having a smaller diameter than the diameter of ball 39. The orifice 43 constitutes a valve seat which, when occluded by ball 39, prevents discharge of the contained liquid.

Valve unit 35 may also be configured with one or more vertical displacement limiting elements 46 protruding inwardly from the inner face 38 of body 37. The lower edge of each identical element 46 is preferably separated from ball 39 by at least approximately 10 mm when seated in orifice 43. Each element 46 may have a triangular cross sectional shape, when longitudinally cut, whose lower surface protrudes radially inwardly from body inner face 38 to the corresponding vertex 48 by a greater dimension than at any other region of the element 46. The distance from one protruding vertex 48 to another, for example of diametrically opposite elements, is less than the diameter of ball 39, and therefore the upward displacement of the ball is limited upon contacting elements 46.

When actuator 16 is pressed, an axial force A is transmitted to an element of the compressed air generating mechanism, such as by means of driving member 33 concealed by protective covering 32. The element of the compressed air generating mechanism to which axial force A is transmitted expands in response to the applied force, thus reducing the available volume of an air-deliverable chamber which is in fluid communication with orifice 43. As a result of the reduction in volume of the air-deliverable chamber in fluid communication with orifice 43, air confined therewithin becomes compressed. Since the air pressure within the interior of the air-deliverable chamber becomes greater than the pressure within the bottle interior, an unseating force U is applied onto ball 39 by the differential force between the interior of the air-deliverable chamber and the bottle interior, causing the ball to rise. The axial length of transfer member 15 is sufficient to facilitate pressing actuator 16 with the thenar eminence while fingers of the actuating hand are in engagement with endwall 27 of horizontal tube 13.

As ball 39 becomes unseated, the liquid contained within the inverted bottle that has gravitated within the neck is now free to flow downwardly through orifice 43. Through cooperation of the air generating mechanism, a dose of liquid such as viscous liquid contained within the inverted bottle will be speedily and reliably dispensed into the actuating hand. Upon release of axial force A, the pressure within the interior of the air-deliverable chamber and the bottle interior becomes equated and ball 39 consequently becomes reseated within orifice 43.

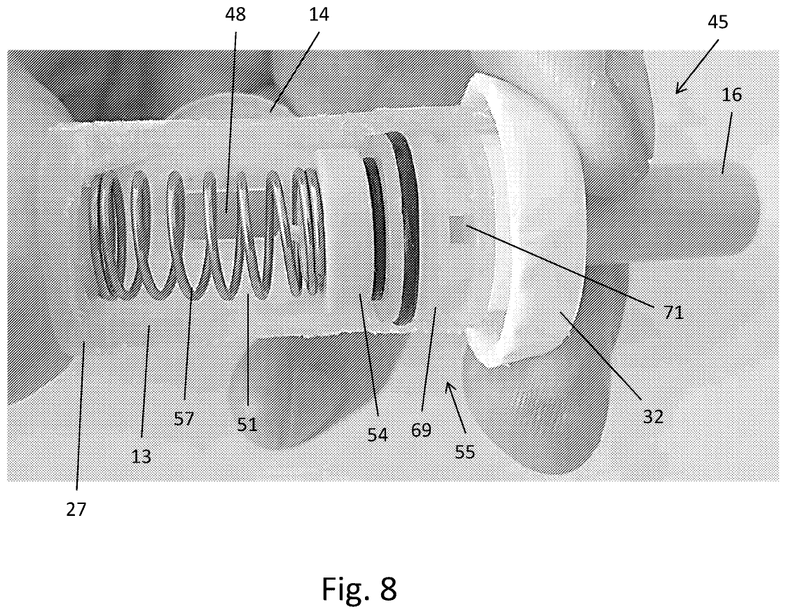

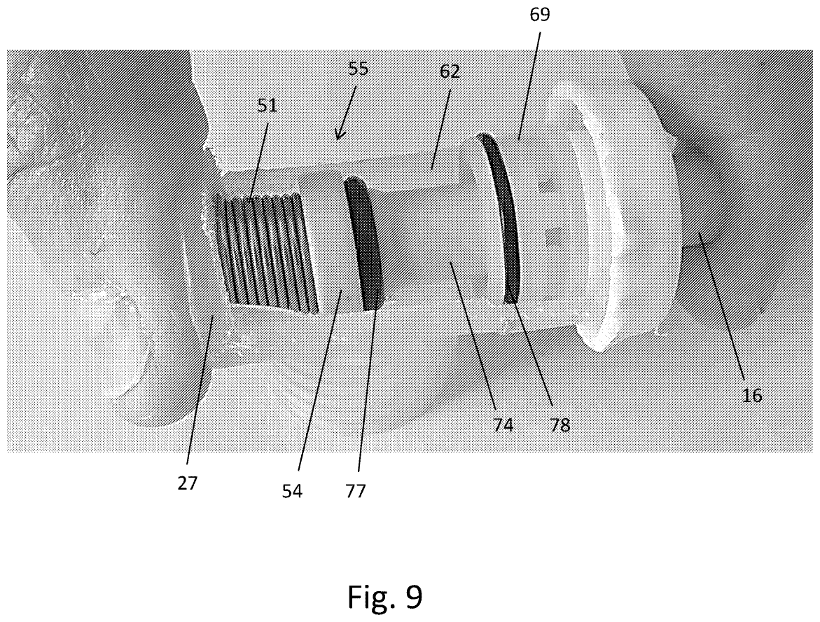

FIGS. 8 and 9 illustrate an embodiment of a tubular transfer member 45. In this embodiment, the air generating mechanism 55 comprises a variable-length spring chamber 51 which constitutes the air-deliverable chamber, a collapsible transfer chamber 62, annular interface element 69 which is positioned adjacent to protective covering 32, and actuator 16.

Spring chamber 51, within which helical spring 57 is positioned, is contiguous with endwall 27 and is circumferentially enclosed by horizontal tube 13. The volume of spring chamber 51 is defined by an axially displaceable circular partition 54, which is sealingly engaged with the inner face of horizontal tube 13. The two ends of helical spring 57 are connected to corresponding faces of endwall 27 and partition 54, respectively.

Actuator 16 is connected to partition 54, extending through the center of interface element 69 and through an intervening sleeve 74 that is also connected at a first end to partition 54. A second end of sleeve 74 is unconnected. A first sealing ring 77 encircles sleeve 74 at the region of connection with partition 54, and a second sealing ring 78 in sealing engagement with the inner face of horizontal tube 13 is fitted in interface element 69.

Ambient air is admitted to the interior of spring chamber 51 through check valve equipped inlet 17 (FIG. 4), which penetrates horizontal tube 13, and the spaced windings of helical spring 57. Spring chamber 51 is in fluid communication with vertical tube 14 via interconnecting aperture 48.

Prior to application of the axial force onto actuator 16, helical spring 57 is in a relaxed and extended state, and actuator 16 protrudes to a full extent from interface element 69, as shown in FIG. 8. Also, first sealing ring 77 is in contact with interface element 69 while the sleeve is retracted into a central region of protective covering 32 and interface element 69.

Following application of the axial force onto actuator 16 as shown in FIG. 9, actuator 16 is pressed and retracted towards endwall 27. The axial force is transmitted to partition 54, causing the latter to be axially displaced towards endwall 27 and helical spring 57 to be compressed. The length and volume of spring chamber 51 are consequently reduced, resulting in compression of air confined therewithin.

The higher pressure air within the spring chamber interior is consequently caused to flow through vertical tube 14 towards the lower pressure bottle interior while applying the unseating force as described hereinabove.

Simultaneously with application of the axial force, transfer chamber 62 is defined between first sealing ring 77 and interface element 69 and of a length equal to the reduction in length of spring chamber 51. In response to application of the unseating force resulting from the generated compressed air, a dose of the contained liquid is discharged through the unseated valve aperture 48 into transfer chamber 62.

Upon release of the axial force, the valve becomes reseated and partition 54 returns to its original position shown in FIG. 8 that is adjacent to interface element 69 by action of the uncompressed spring. The proximal displacement of partition 54 forces the discharged liquid into the central region of interface element 69 and through apertures 71 and port 46 into the actuating hand. It will be appreciated that the pressure within the spring chamber will eventually be equated with the pressure within the bottle interior to cause reseating of the valve and prevention of discharge of another dose of liquid even if the axial force is not released.

A dispensing operation is therefore carried out in conjunction with transfer member 45 by the following five steps: (1) applying an axial force onto the actuator to reduce the volume of the spring chamber and cause formation of the transfer chamber, (2) generating compressed air in the reduced-volume spring chamber, (3) unseating the valve by the generated compressed air, (4) allowing a dose of contained liquid to be discharged from the bottle through the clearance provided by the unseated valve into the transfer chamber, and (5) releasing the axial force to cause retraction of the actuator and dispensing of the discharge liquid via the collapsed transfer chamber.

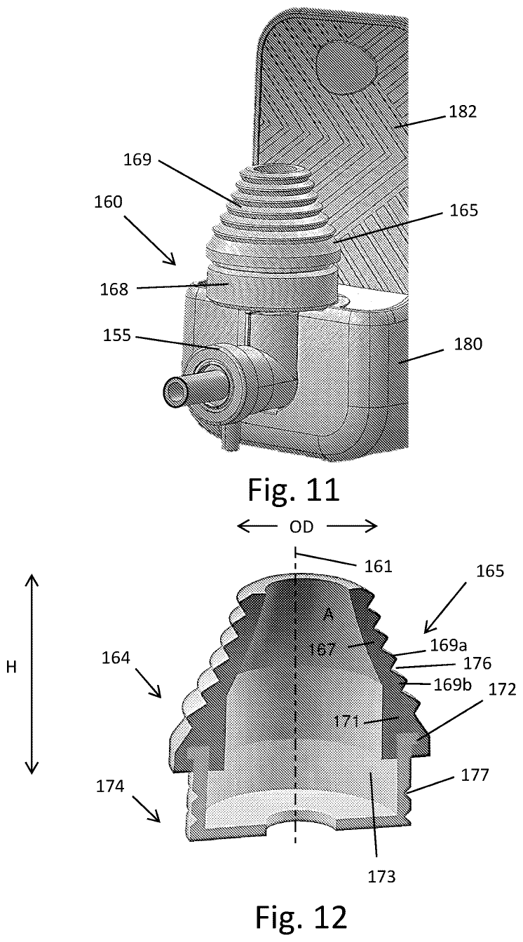

In another embodiment shown in FIGS. 11-12, a liquid dispenser 160 comprises transfer member 155, annular base 168 releasably engageable and in fluid communication with an element of transfer member 155, and a universal adapter 165 releasably or irremovably coupleable with base 168 that is adapted for securement within the opening at an unoccluded terminal end of an inverted bottle containing a desired liquid, such as at the neck of the bottle, through which the desired liquid is dischargeable. Transfer member 155, which is structured and functions similarly as transfer member 45 of FIG. 8, is supported by wall mount 180 having a substantially vertical mounting surface 182.

As shown, adapter 165 is of annular frusto-conical construction in order to accommodate terminal bottle openings of many different sizes. Adapter 165 comprises an upper sealing section 164 securable within the bottle opening and a lower connection section 174 that may be releasably engageable with base 168 such as by threading 177.

The upper oblique wall 167 of sealing section 164 defining the frusto-conical construction is of uniform thickness and angle relative to the longitudinal axis 161 of adapter 165. Wall 167, which defines the inner diameter ID of sealing section 164 that ranges for example from 10-50 mm and a channel through which liquid is dispensable, may be disposed at an angle A ranging for example from 5-70 degrees relative to axis 161, e.g. 45 degrees. Sealing section 164 is additionally configured with a lower thickened wall 171 that has a non-oblique inner surface, i.e. being completely uniformly spaced from axis 161. Lower thickened wall 171 is integrally formed with oblique wall 167 and is attached to the upper lip 172 of the annular and inner threaded non-oblique wall 173 of connection section 174. The height H of sealing section 164 may range from 5-100 mm. A relatively long sealing section 164 is suitable for being securely and sealingly inserted within a bottle neck.

Sealing section 164 is generally, but not necessarily, made of elastomeric material such as silicone to facilitate elastic deformation upon being coupled to, or detached from, a given inverted liquid bottle and to seal the edge surrounding the bottle opening against unwanted liquid leakage. The elastomeric material is preferably a fluid-impervious, resilient, and inert material to prevent any alteration of the liquid being discharged or of the adapter.

A plurality of soft sealing rings 169 which are integrally formed with oblique wall 167 protrude radially outwardly from the wall by a uniform protruding distance to define an outer diameter OD of sealing section 164 that ranges from 12-75 mm while the OD of sealing section 164 between adjacent sealing rings ranges from 11-55 mm. The soft sealing rings 169 are arranged in parallel formation from top to bottom. As adapter 165 is frusto-conical, the outer diameter OD of an upper ring is smaller than a lower ring.

When it is desired to couple liquid dispenser 160 with a desired inverted bottle, the bottle is lowered with respect to sealing section 164, causing the various sealing rings 169 that are contacted by the edge surrounding the bottle opening to be stretched in response to the force applied by the bottle opening edge that is being lowered. A stretched sealing ring snaps into position in contact with, and presses firmly on, a planar terminal end surface surrounding the opening when the sealing ring immediately thereunder is unable to be inserted through the opening due to its outer diameter that is greater than that of the opening. The oblique wall portion 176 interposed between, or positioned at the intersection of, the snapped sealing ring 169a and the sealing ring 169b immediately thereunder sealingly engages the bottle opening edge.

Sealing section 164 therefore facilitates adaptability to differently sized bottle openings by being able to be sealingly engaged with the corresponding bottle opening edge. After a selected bottle is disengaged from adaptor 165, sealing section 164 is once again available for sealingly engaging another bottle having a same sized, or a differently sized, opening as the previously coupled bottle containing a desired liquid. According to some embodiments of the invention, the conic sealing section is not limited to a structure made up of concentric rings with sequentially decreasing diameters. Instead, this embodiment allows for the outer surface of the conic sealing section to be partially or completely smooth, thus accommodating variations in the conic form (e.g., it may combine areas of concentric rings with sequentially decreasing diameters and areas that are completely smooth, or the sealing section 164 can be completely smooth as shown with respect to an adaptor 265 in FIG. 17. In this example, adaptor 265 has a smooth conic portion as indicated by numeral 269).

In other embodiments, by virtue of its adaptability to differently sized bottle openings, adapter 165 is configured without any threading while connection section 174 is irremovably coupled with, or attached to, base 168, such as by adhesion or by being integrally formed with the base.

Also, in other embodiments, the throat of base 168 may be configured without any threading so as to be irremovably coupled with, or attached to, the vertical tube of transfer member 155, such as by adhesion or by being integrally formed therewith.

It will be appreciated that the sealing section of adapter 165 may be adapted to be sealingly engaged with a non-circular bottle opening. Such a sealing section may also be of frusto-conical construction having parallel sealing rings, but of a periphery that corresponds to the shape of the bottle opening.

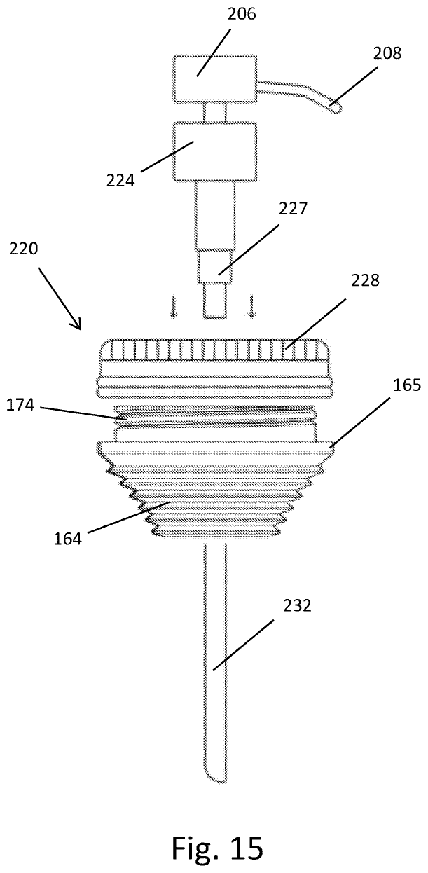

In another embodiment, annular frusto-conical adapter 165 may be implemented for use in conjunction with the hygiene promoting liquid soap dispenser 220 shown in FIG. 15.

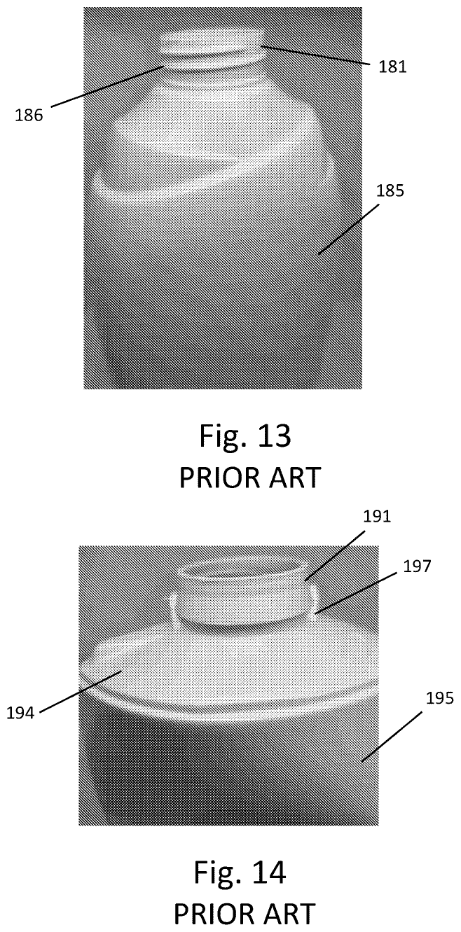

Liquid soap bottles from which the liquid soap is dispensed with an actuator are generally manufactured with one of two different coupling means. In the first type shown in FIG. 13, the neck 181 of soap bottle 185 is formed with threading 186, usually external threading, that facilitates threaded engagement with a dedicated closure of the dispenser. In the second type shown in FIG. 14, the annular neck 191 of soap bottle 195 is smooth, being factory manufactured with a smooth neck or a smooth annular appendage being affixed to the existing neck. A push-in type of dispenser is coupled with neck 191 of soap bottle 195 by being engaged with frictional elements, such as frictional elements 101 and 102 of FIG. 10.

The two different coupling means are mutually exclusive to discourage use of the dispenser of the first type with the bottle of the second type, and vice versa. Two thin and elongated screwing inhibitors 197 are attached to neck 191 at diametrically opposite intermediate regions thereof so as to accommodate the neck curvature, being also attached to the shoulder 194 of soap bottle 195. Thus a threaded dispenser closure is prevented from being securely coupled with soap bottle 195, such as by biting into annular smooth neck 191, due to the presence of screwing inhibitors 197 that inhibit no more than two turns of the closure. Conversely, a push-in dispenser closure is incapable of being coupled with soap bottle 185 due to the lack of threading provided with the closure and the lack of frictional elements provided with the soap bottle.

Universal liquid soap dispenser 220 shown in FIG. 15, usually used for above counter use, is advantageously able to be sealingly coupled with both soap bottle 185 and soap bottle 195, and is able to detached from one and coupled with the other when desired, to obviate the need of storing two types of soap bottles or two types of closures.

Soap dispenser 220 illustrated in exploded form comprises frusto-conical adapter 165, actuator 206, pump member 224, lip adapter 228, and flexible conduit 232 which may be made of transparent or translucent plastic material. Annular lip adapter 228 configured with internal threading is attached to a distal housing element 227 of pump member 224 such as by adhesive attachment, mechanical attachment which may be releasable, integral factory manufacturing, or any other means well known to those skilled in the art. Known components such as a piston and a spring are retained within the housing elements of pump member 224. Conduit 232 is then attached to the distal end of pump member 224, such as by frictional engagement, and is in liquid communication therewith while extending through the central opening of lip adapter 228. While threaded connection section 174 of frusto-conical adapter 165 is positioned above sealing section 164 and conduit 232 is received within the internal channel of adapter 165, connection section 174 and lip adapter 228 are threadedly coupled together by rotating one relative to the other.

Once adapter 165 is coupled with dispenser 220, sealing section 164 is able to be sealingly coupled within the neck of the soap bottle regardless of the dimensions of the bottle neck, as described above.

Other types of variably shaped universal adapters configured with an internal channel to accommodate the dispensed soap or other types of liquid may also be connected with lip adapter 228 or other suitable closures. As referred to herein, a “variably shaped adapter” is one that is suitably shaped or dimensioned at different cross sections thereof to facilitate sealing securement within the interior of correspondingly differently sized bottle necks or terminal ends of a bottle.

It will be appreciated that dispenser 160 of FIG. 11 may also be configured with a variably shaped adapter.

Upon applying a manual force to actuator 206, the piston within pump member 224 is displaced in conjunction with the compressible spring to generate suction as well known to those skilled in the art, urging the liquid soap to flow upwardly from the interior of the upright soap bottle and through conduit 232. The upwardly flowing liquid soap flows past a unidirectional valve such as a ball valve into a liquid chamber, and is prevented from flowing downwardly back to the bottle interior. When actuator 206 is pressed a second time, the liquid soap within the chamber will be drawn from the chamber and dispensed through spout 208.

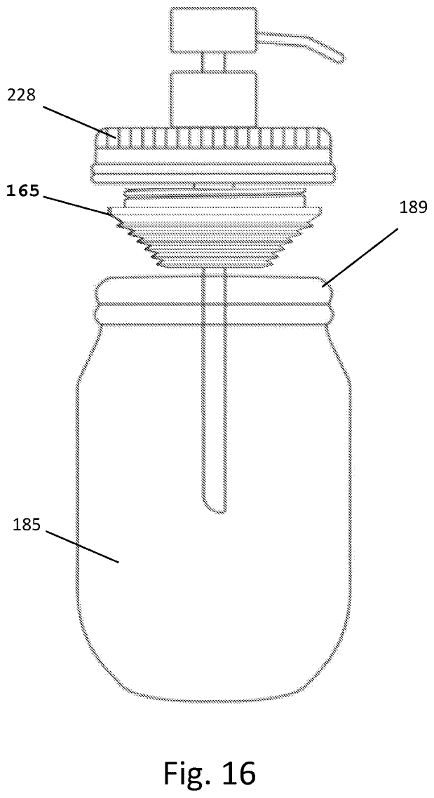

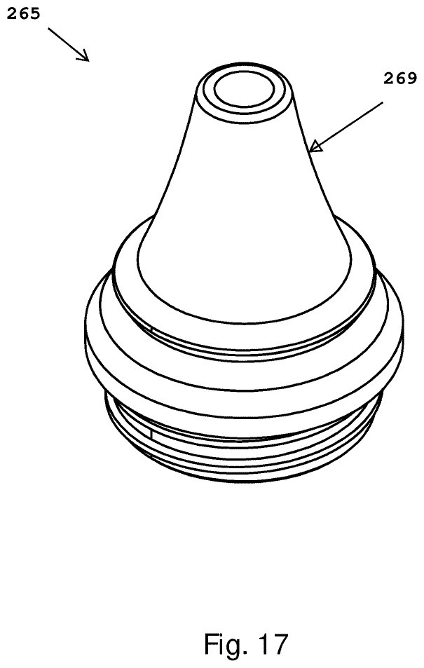

If so desired as shown in FIG. 16, lip adapter 228 is able to be decoupled from adapter 165 and be threadedly connected to the threading of soap bottle 185 at lip 189.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A liquid dispenser for one-handed dispensing, comprising:
a) a substantially horizontal and longitudinally closed transfer member configured with a manual compressed air generating mechanism, wherein said transfer member is contactable by a first portion of an actuating hand;
b) a substantially horizontal actuator operatively coupled with said transfer member to which an actuating force is appliable with a second portion of the same actuating hand;
c) an adapter with which an unoccluded terminal end of an inverted bottle containing a desired liquid and in liquid communication with the transfer member is releasably securable;
d) a base with which the adapter is engageable, the base configured with a downwardly extending throat that is engageable and in fluid communication with, an element of the transfer member;
e) a valve unit seatable in a valve seat provided with the throat of the base, the valve unit configured to prevent unwanted liquid from being discharged through the unoccluded terminal end of the inverted bottle; and
f) a fluid exchange port in fluid communication with the transfer member,
wherein an unseating force causing the valve unit to become unseated from the valve seat and the contained liquid to be gravitationally discharged through the valve unit and through the transfer member is appliable onto the valve unit by compressed air that is generated by the compressed air generating mechanism within an interior of the transfer member upon application of the actuating force,
wherein a dose of the contained liquid is dispensable via the transfer member and the fluid exchange port into the actuating hand upon application of the actuating force with the second portion of the actuating hand.

2. The dispenser according to claim 1, wherein the compressed air generating mechanism comprises an air-deliverable chamber which is in fluid communication with an orifice of the valve unit and an expandable element in force transmitting relation with the actuator, the expandable element configured to expand in response to the applied force and to cause a volume of the air-deliverable chamber to become reduced and to generate the compressed air.

3. The dispenser according to claim 2, wherein the transfer member is additionally configured with a transfer chamber isolated from the air-deliverable chamber within which the dose of the contained liquid discharged through the valve unit is received prior to being dispensed via the fluid exchange port.

4. The dispenser according to claim 1, wherein the base is annular and the element of the transfer member with which the throat is engageable is a tube upwardly extending from, and in fluid communication with, a substantially horizontal tube of the transfer chamber.

5. The dispenser according to claim 1, wherein the valve unit is releasably engageable to an inner face of the throat of the base.

6. The dispenser according to claim 5, wherein the valve unit comprises a tubular body, a solid unbored ball which is vertically displaceable within an interior of the body, and a lower surface configured with an orifice constituting the valve seat which is seatable by the ball in order to prevent discharge of the contained liquid.

7. The dispenser according to claim 6, wherein the valve unit is additionally configured with one or more vertical displacement limiting elements protruding inwardly from an inner face of the tubular body, upward displacement of the ball in response to application of the unseating force being limited upon contacting one of the vertical displacement limiting elements.

8. The dispenser according to claim 1, wherein the base is releasably engageable with the adapter.

9. The dispenser according to claim 1, wherein the adapter is irremovably coupled with, or attached to, the base.

10. The dispenser according to claim 1, wherein the throat of the base is releasably engageable with an element of the transfer member.

11. The dispenser according to claim 1, wherein the throat of the base is irremovably coupled with, or attached to, an element of the transfer member.

12. The dispenser according to claim 1, wherein the adapter comprises a sealing section that is securable within a bottle opening at the unoccluded terminal end of the inverted bottle, and a connection section for connection with the base.

13. The dispenser according to claim 12, wherein the sealing section is of annular frusto-conical construction.

14. The dispenser according to claim 13, wherein the sealing section comprises a peripheral wall that is oblique relative to a longitudinal axis of the adapter, and a plurality of sealing rings which are integrally formed with the oblique wall.

15. The dispenser according to claim 1, wherein the adapter comprises one or more elements for frictionally holding the terminal end of the inverted bottle, and a connection section for connection with the base.

16. The dispenser according to claim 1, which is suitable for dispensing of a viscous liquid.

17. A system, comprising the dispenser according to claim 1 and a mounting element by which the dispenser is supported.

18. A manually operated universal liquid dispenser, comprising a transfer member configured with a manual compressed air generating mechanism, an actuator mechanically connected to the transfer member, an annular closure configured with threading that is attached to a distal housing element of the transfer member, a flexible conduit attached to a distal end of the transfer member, and an annular variably shaped adapter comprising a sealing section and a threaded connection section, wherein the connection section of the adapter is threadedly engageable with the closure and the sealing section of the adapter is sealingly securable within an interior of a neck of a bottle while the conduit is introducible through the interior of the bottle neck so as to be in liquid communication with the liquid contained within the bottle, and wherein the liquid contained within the bottle is dispensable upon manipulation of the actuator and generation of compressed air by the manual compressed air generating mechanism.

19. The dispenser according to claim 18, wherein the adapter is removable from the bottle neck of a first size and is sealingly securable within the interior of a bottle neck of a second size.

20. The dispenser according to claim 18, wherein the adapter is of frusto-conical construction.

21. The dispenser according to claim 20, wherein the adapter comprises a plurality of parallel integral sealing rings.

22. A system, comprising the dispenser according to claim 18 and a bottle containing a liquid which is configured with a neck within an interior of which the sealing section of the adapter is sealingly securable.
